(19) United States
(12) Patent Application Publication
(10) Pub. No.: US 2026/0278855 A1
(43) Pub. Date: Sep. 17, 2026

(54) IMAGE GENERATION DEVICE, IMAGE GENERATION METHOD, AND RECORDING MEDIUM

(71) Applicant: NEC Corporation, Tokyo (JP)

(72) Inventors: Nozomi TABATA, Tokyo (JP); Shinji CHICHIBU, Tokyo (JP)

(73) Assignee: NEC Corporation, Tokyo (JP)

(21) Appl. No.: 19/557,712

(22) Filed: Mar. 5, 2026

(30) Foreign Application Priority Data
Mar. 17, 2025 (JP) 2025-042487

(51) Int. Cl. G06T 11/00; G06F 16/532; G06T 13/80

(52) U.S. Cl. CPC G06T 11/00; G06F 16/532; G06T 13/80

(57) ABSTRACT

In order to provide an image generation device capable of easily visualizing, utilizing generative AI, what is intended to be conveyed with predetermined data, a processor acquire visualization data that is data intended to be visualized. The processor analyzes the visualization data and extracting features. The processor generates a theme obtained by conceptualizing the visualization data based on the features. The processor acquires external data with respect to the visualization data. The processor generates a prompt including a design representing the visualization data based on the theme and the external data. The processor generates, based on the prompt, a conceptual image in which the external data is reflected.

### INCORPORATION BY REFERENCE

This application is based upon and claims the benefit of priority from Japanese Patent Application 2025-042487, filed on Mar. 17, 2025, the disclosure of which is incorporated herein in its entirety by reference.

### TECHNICAL FIELD

The present disclosure relates to a technique for generating images.

### BACKGROUND ART

In recent years, it has been known to generate images by leveraging generative artificial intelligence (AI). Generative AI tools that provide support for users to draw pictures have also been known. Patent Document 1 describes an information processing device that determines a concept by clustering feature vectors acquired from a plurality of images, and generates an image for expressing the concept.

Patent Document 1: International Publication Pamphlet No. WO2023/176445

### SUMMARY

The conventional generative AI tools are interactive and often generate images limited to ranges described as prompts. Thus, in a case where a user tries to draw a picture utilizing generative AI, for instance, the user himself or herself has to craft composition and issue meticulous instructions for drawing the picture. At this time, in a case where an abstraction level of the user's instructions is high, it is difficult to suitably shape what is intended to be conveyed into the picture. There are some generative AI tools that automatically generate figures and PowerPoint (registered trademark) materials; however, there has been a problem in that such tools are not good at expressing a conventionally non-existent object and cannot express the object as a picture.

One object of the present disclosure is to provide an image generation device capable of easily visualizing, utilizing generative AI, what is intended to be conveyed with predetermined data.

According to an example aspect of the present invention, there is provided an image generation device including:

at least one memory configured to store instructions; and

at least one processor configured to execute the instructions to:

acquire visualization data that is data intended to be visualized;

analyze the visualization data and extracting features;

generate a theme obtained by conceptualizing the visualization data based on the features;

acquire external data with respect to the visualization data;

generate a prompt including a design representing the visualization data based on the theme and the external data; and

generate, based on the prompt, a conceptual image in which the external data is reflected.

According to another example aspect of the present invention, there is provided an image generation method executed by an image generation device, the image generation method including:

acquiring visualization data that is data intended to be visualized;

analyzing the visualization data and extracting features;

generating a theme obtained by conceptualizing the visualization data based on the features;

acquiring external data with respect to the visualization data;

generating a prompt including a design representing the visualization data based on the theme and the external data; and

generating, based on the prompt, a conceptual image in which the external data is reflected.

According to still another example aspect of the present invention, there is provided a non-transitory computer-readable recording medium storing a program executed by an image generation device including a computer, the program causing the computer to execute processing of

acquiring visualization data that is data intended to be visualized,

analyzing the visualization data and extracting features,

generating a theme obtained by conceptualizing the visualization data based on the features,

acquiring external data with respect to the visualization data,

generating a prompt including a design representing the visualization data based on the theme and the external data, and

generating, based on the prompt, a conceptual image in which the external data is reflected.

### EFFECT

According to the present disclosure, the image generation device capable of easily visualizing, utilizing the generative AI, what is intended to be conveyed with predetermined data, is provided.

### BRIEF DESCRIPTION OF THE DRAWINGS

FIG. 1 illustrates an example of a schematic configuration of an image generation system according to the present disclosure;

FIG. 2 is a diagram for explaining image generation processing performed by a server;

FIGS. 3A and 3B are block diagrams illustrating examples of hardware configurations of the server and a user terminal;

FIG. 4 is a block diagram illustrating an example of a functional configuration of the server;

FIG. 5 illustrates an example of an input screen;

FIG. 6 illustrates an example of an initial prompt;

FIG. 7 illustrates examples of insights;

FIGS. 8A-8D illustrate examples of keywords and stories;

FIG. 9 illustrates an example of a journey;

FIGS. 10A and 10B illustrate examples of image generation prompts;

FIG. 11 illustrates an example of a conceptual image;

FIG. 12 is a flowchart illustrating an example of the image generation processing performed by the server;

FIG. 13 is a block diagram illustrating a functional configuration of an image generation device; and

FIG. 14 is a flowchart of the image generation device.

### EXAMPLE EMBODIMENTS

Hereinafter, example embodiments of the present disclosure will be described with reference to the drawings.

### First example embodiment

### Overall configuration

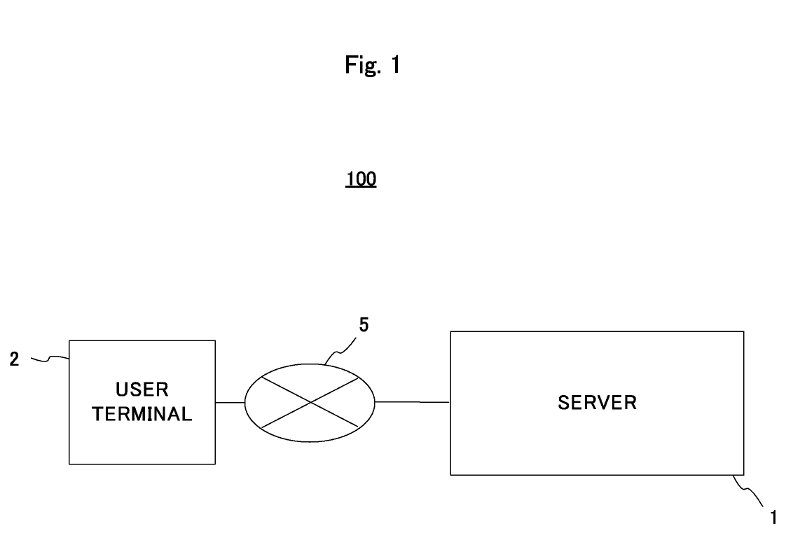

FIG. 1 illustrates an example of a schematic configuration of an image generation system 100 to which an image generation device of the present disclosure is applied. The image generation system 100 is a system capable of easily visualizing, by utilizing generative AI, what is intended to be conveyed with predetermined data. The visualization is to generate, with respect to the predetermined data, such as audio data, sentence data, and image data, a conceptual image visually expressing what is intended to be conveyed with these pieces of data. Here, the conceptual image is an image including a picture, artwork, a graph, a table, or the like, and can be freely set.

In the image generation system 100 in FIG. 1, a server 1 and a user terminal 2 are communicably connected through a network 5, such as the Internet. A user is a person who requests the visualization with the predetermined data.

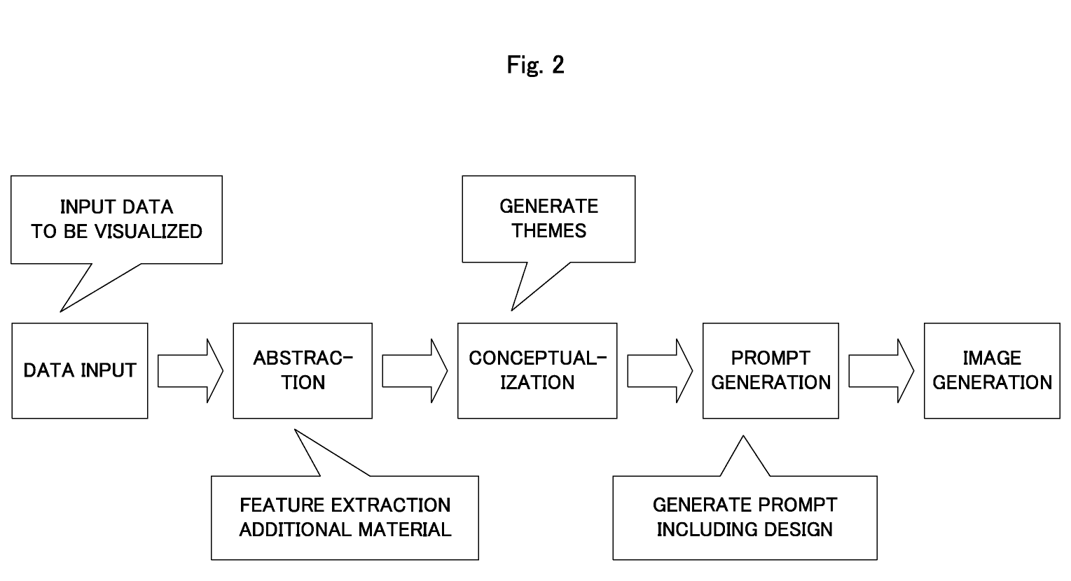

FIG. 2 is a diagram for explaining image generation processing by the server 1. As illustrated in FIG. 2, the image generation processing is composed of steps of data input, abstraction, conceptualization, prompt generation, and image generation. The user first inputs, by using the user terminal 2, data (hereinafter, also referred to as “visualization data”) intended to be visualized by a predetermined operation. In the image generation system 100, only by inputting the predetermined data and making an image request, the user can easily acquire the conceptual image in which what is intended to be conveyed with the data is visualized. In other words, by utilizing the generative AI, the server 1 determines how to convey the data acquired from the user terminal 2 and generates the visualized conceptual image.

As illustrated in FIG. 2, the server 1 first performs abstraction of the visualization data input by the user. Specifically, the server 1 analyzes a background and an event with respect to the visualization data, thereby exercising comprehension of a large volume of perceptual data and a large number of meanings, extracting features, and then organizing relations. The server 1 may acquire additional material from the Internet and/or a predetermined database (hereinafter, also referred to as “DB”) with respect to the visualization data, and perform extraction of features and organization of relations with reference to the additional material.

Next, the server 1 performs conceptualization of the visualization data as illustrated in FIG. 2. The server 1 conceptualizes the visualization data anew with respect to the features and the relations therebetween and expresses the visualization data in different forms, thereby making a structure that facilitates conveyance to persons. Specifically, the server 1 generates a theme obtained by conceptualizing the visualization data based on the visualization data as well as the features and the relations therebetween. The theme is, for instance, a keyword, a catchphrase, a journey, a story, and/or the like representing essence and/or nature of the visualization data, and can be freely set as long as the theme is a conceptual representation of the visualization data.

Next, as illustrated in FIG. 2, the server 1 generates an image generation prompt by employing the generative AI. Specifically, the server 1 generates an image generation prompt including a design by employing mermaid syntax or the like with respect to the visualization data, the features and the relations therebetween, and the theme. The design is, for instance, screen composition, tone and manner, a use of an image, a reference image, and/or the like, and can be freely set as long as these items relate to a design of the image representing the visualization data. Here, the tone and manner is a rule for which what impression the design has is specified, and examples thereof include a color tone and an atmosphere.

The visualization data, the features and the relations therebetween, the theme, and the like, and the image generation prompt are input to the generative AI, so that the server 1 generates a conceptual image in which a purpose and the background intended to be conveyed with the visualization data are incorporated. This enables the user to easily generate an image, such as a picture and artwork, in which the purpose and the background intended to be conveyed are intuitively conveyed to other persons.

The generative AI used by the server 1 in each step may have the same model applied thereto, or have different models applied thereto depending on a purpose and the like of the processing of each step.

The server 1 is an information processing device that performs processing on, and storage and transmission and reception of various types of data, and receives the visualization data from the user terminal 2 and transmits data on the conceptual image to the user terminal 2. The server 1 may be a virtual server residing in a cloud environment. The server 1 is an example of the image generation device of the present disclosure.

The user terminal 2 is a smartphone, a tablet, a PC, or the like used by the user, and transmits the visualization data to the server 1 and acquires the data on the conceptual image from the server 1.

### Hardware configuration

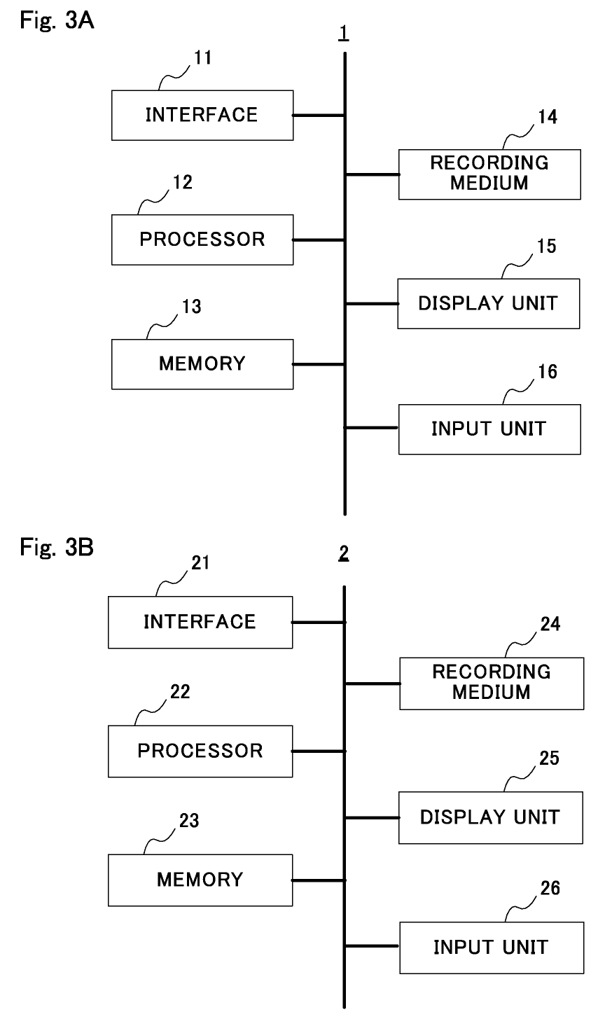

FIG. 3A is a block diagram illustrating an example of a hardware configuration of the server 1. As illustrated in the figure, the server 1 includes an interface 11, a processor 12, a memory 13, a recording medium 14, a display unit 15, and an input unit 16.

The interface 11 exchanges the data with the user terminal 2. The interface 11 is used in a case where the visualization data is received from the user terminal 2 and the conceptual image is transmitted to the user terminal 2.

The processor 12 is a computer, such as a central processing unit (CPU), and controls the entire server 1 by executing programs prepared in advance. As the processor 12, a CPU, a Graphics Processing Unit (GPU), a Digital Signal Processor (DSP), a Micro Processing Unit (MPU), a Floating Point Unit (FPU), a Physics Processing Unit (PPU), a Tensor Processing Unit (TPU), a quantum processor, a microcontroller, a combination of these, or the like, can be employed.

The memory 13 is configured with a read-only memory (ROM), a random-access memory (RAM), or the like. The memory 13 stores the programs executed by the processor 12. The memory 13 is also used as a working memory during execution of various pieces of processing by the processor 12.

The recording medium 14 is a non-volatile and non-transitory recording medium, such as a disk-shaped recording medium and a semiconductor memory, and is configured removably from the server 1. The recording medium 14 records various programs executed by the processor 12. In order for the server 1 to perform the image generation processing, which will be described later, programs recorded in the recording medium 14 are loaded into the memory 13 and executed by the processor 12.

The display unit 15 is, for instance, a liquid crystal display (LCD), and displays various images during an operation of the server 1. The input unit 16 is a keyboard, a mouse, a touchscreen, or the like, and is used by an operator who manages the server 1.

FIG. 3B is a block diagram illustrating an example of a hardware configuration of the user terminal 2. As illustrated in the figure, the user terminal 2 includes an interface 21, a processor 22, a memory 23, a recording medium 24, a display unit 25, and an input unit 26.

The interface 21 exchanges the data with the server 1 via the network 5. The interface 21 is used in a case where the visualization data from the user is transmitted to the server 1 and the conceptual image is received from the server 1.

The processor 22 is a computer, such as a CPU, and controls the entire user terminal by executing programs prepared in advance. As the processor 22, a CPU, a GPU, a DSP, an MPU, an FPU, a PPU, a TPU, a quantum processor, a microcontroller, a combination of these, or the like can be employed.

The memory 23 is configured with a ROM, a RAM, or the like. The memory 23 stores the programs executed by the processor 22. The memory 23 is also used as a working memory during execution of various pieces of processing by the processor 22.

The recording medium 24 is a non-volatile, non-transitory recording medium, such as a disk-shaped recording medium and a semiconductor memory, and is configured removably from the user terminal 2. The recording medium 24 records various programs executed by the processor 22. The display unit 25 is, for instance, an LCD, and displays various images during an operation of the user terminal 2 performed by the user. The input unit 26 is a touchscreen or the like, and is used in a case where the user performs a predetermined operation.

### Functional configuration

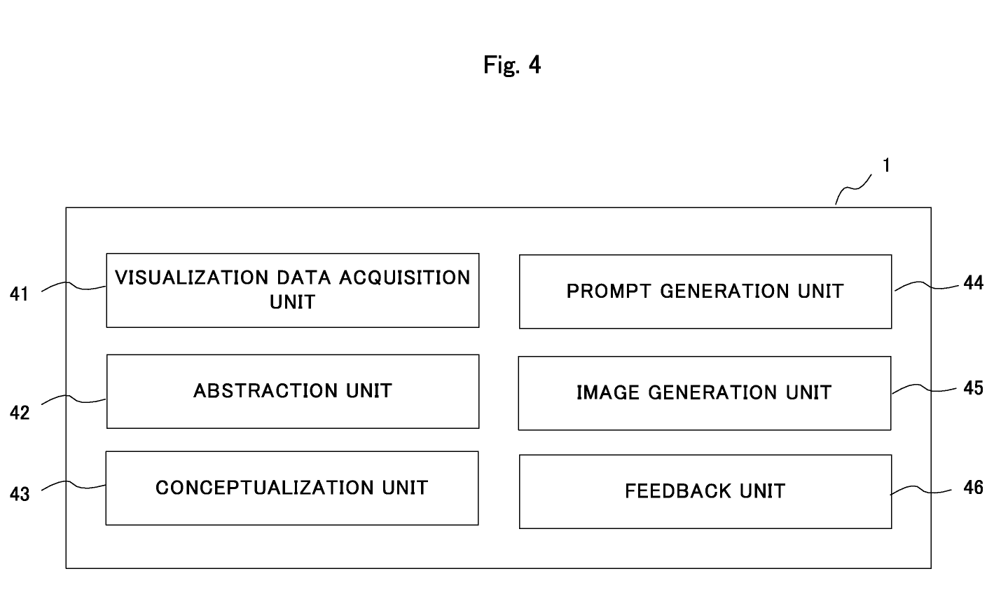

FIG. 4 is a block diagram illustrating an example of a functional configuration of the server 1. The server 1 functionally includes a visualization data acquisition unit 41, an abstraction unit 42, a conceptualization unit 43, a prompt generation unit 44, an image generation unit 45, and a feedback unit 46.

The visualization data acquisition unit 41, the abstraction unit 42, the conceptualization unit 43, the prompt generation unit 44, the image generation unit 45, and the feedback unit 46 are implemented by the processor 12 executing programs.

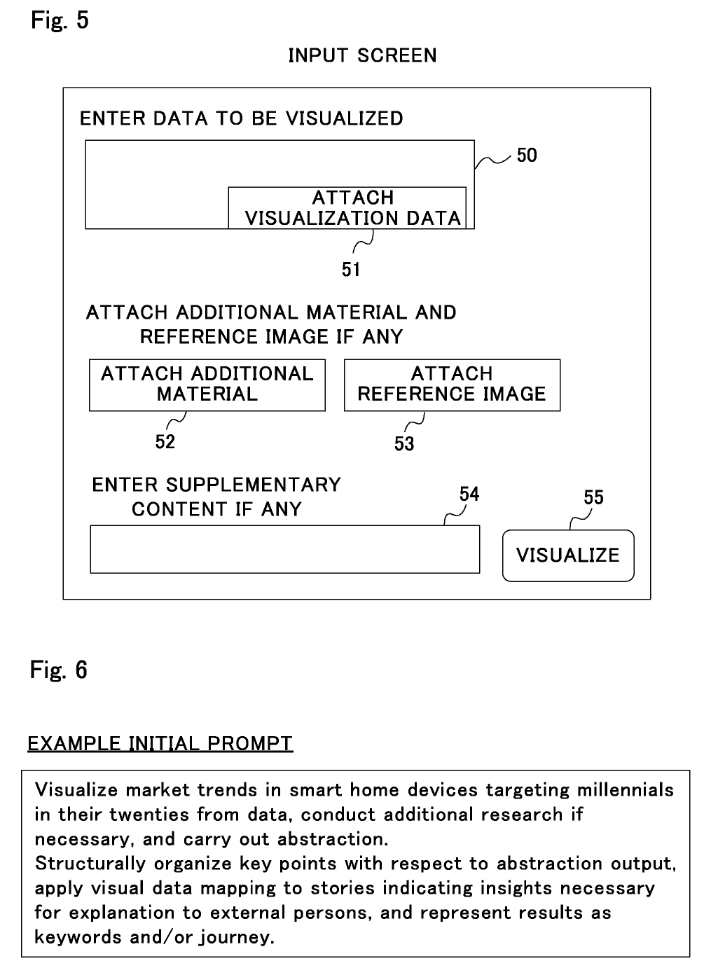

The visualization data acquisition unit 41 acquires the visualization data and the image request from the user terminal 2. FIG. 5 is an example of an input screen displayed on the user terminal 2. As illustrated in FIG. 5, the input screen includes an input item 50, an additional material attaching button 52, a reference image attaching button 53, a supplementary item 54, and a visualization button 55.

The input item 50 is an item to which the visualization data is input, and includes an attaching button 51. The user may input visualization data in text to the input item 50, or may press the attaching button 51 and attach visualization data in any format. In a case where the input screen is integrated with a web conferencing tool, data from a call or a conference is enabled to be adopted as the visualization data as it is. Data in any format, such as sentence data, image data, audio data, and graph data, can be applied to the visualization data. The image data may be still image data or moving image data. In a case where the user presses the visualization button 55, the visualization data and the image request are transmitted from the user terminal 2 to the server 1.

In a case where there is additional material and/or a reference image related to the visualization data, the user can press the additional material attaching button 52 and/or the reference image attaching button 53 and attach the pieces of data. In addition, in a case where there is supplementary content related to the visualization data, the user may input the supplementary content in text to the supplementary item 54. The pieces of data on the additional material and/or the reference image, and the supplementary content in a case where the user presses the visualization button 55, are transmitted from the user terminal 2 to the server 1 together with the visualization data and the image request.

For instance, in a case where the user holds a “conference for drafting a prototype and for an exhibition promoting product values” with a web conferencing tool by using the user terminal 2, the user presses the attaching button 51 on the input screen and attaches conference data as the visualization data. The user presses the additional material attaching button 52 and attaches a “report on target market” in a PDF format and “forecasted sales data” in a CSV format. The user presses the reference image attaching button 53 and attaches “related product image (reference idea)” in a JPEG format. The user inputs “target market: smart home devices targeted for millennials in their twenties” in the supplementary item 54. Data including one or more of the additional material, the reference image, and the supplementary content is also referred to as “related data”.

In a case where the attachment and input of the visualization data and the related data are completed, the user presses the visualization button 55. This leads to the visualization data acquisition unit 41 acquiring the visualization data, and also the additional material, the reference image, and the supplementary content that are the related data, from the user terminal 2 together with the image request.

The input screen illustrated in FIG. 5 is an example, and as long as the server 1 can acquire the visualization data and the image request, the configuration of the input screen, the integrated tool, and the like can be freely set.

The abstraction unit 42 performs the abstraction of the visualization data with reference to the related data. At this time, the abstraction unit 42 may acquire another piece of additional material, for instance, “current market trends as of the acquisition” from the Internet or the predetermined database with respect to the visualization data and the related data, and add the another piece of additional material to the related data. Specifically, the abstraction unit 42 analyzes the visualization data, extracts features, and organizes relations therebetween.

The prompt generation unit 44 to be described later may generate a prompt taking into account the another piece of additional material acquired from the Internet or the predetermined DB, and the image generation unit 45 may generate a conceptual image in which the another piece of additional material is reflected. The another piece of additional material acquired from the Internet or the predetermined DB is an example of external data in the present disclosure.

The conceptualization unit 43 performs the conceptualization of the visualization data with reference to the related data. Specifically, the conceptualization unit 43 generates themes obtained by conceptualizing the visualization data based on the visualization data and the related data, and the features and the relations therebetween acquired in the abstraction of the visualization data.

FIG. 6 illustrates an example of an initial prompt. The abstraction unit 42 and the conceptualization unit 43 perform the abstraction and the conceptualization of the visualization data by inputting the visualization data, the related data, and the initial prompt to the generative AI. As illustrated in FIG. 6, in the initial prompt, an instruction of the abstraction is issued with the first-half sentences: “Visualize market trends in smart home devices targeting millennials in their twenties from the data, conduct additional research if necessary, and carry out the abstraction”, and an instruction of the conceptualization is issued with the second-half sentences: “Structurally organize key points with respect to the abstraction output, apply visual data mapping to stories indicating insights necessary for explanation to external persons, and represent the results as keywords and/or a journey.”.

Here, the visual data mapping is to analyze the visualization data and the related data and represent relations and correlations between the pieces of data as a visual map. Specifically, the conceptualization unit 43 analyzes the visualization data and the related data employing the generative AI, and for instance, takes “usability for millennials”, “value for money”, and the like as key points, and generates a visual map indicating relations and correlations between these points and the pieces of data.

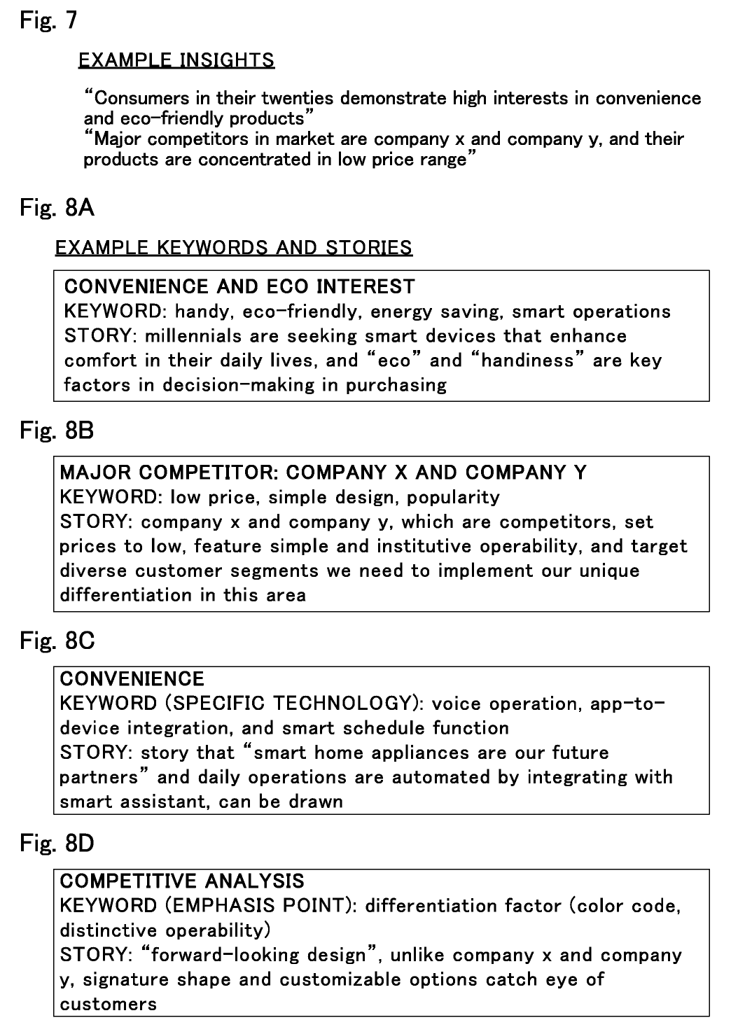

FIG. 7 illustrates examples of the insights. Specifically, the conceptualization unit 43 analyzes the visualization data and the related data employing the generative AI to which the initial prompt is input, and sets, as the insights, “Consumers in their twenties demonstrate high interests in convenience and eco-friendly products” and “Major competitors in the market are company X and company Y, and their products are concentrated in the low price range”, as illustrated in FIG. 7.

FIGS. 8A-8D illustrate examples of the keywords and the stories. The conceptualization unit 43 acquires, from the generative AI to which the initial prompt is input, the keywords and the stories as illustrated in FIGS. 8A-8D with the themes obtained by conceptualizing the visualization data. FIG. 8A illustrates a keyword and a story with a focus on “convenience and eco interest” included in the insight. FIG. 8B illustrates a keyword and a story with a focus on “major competitors are company X and company Y” included in the insight. FIG. 8C illustrates a keyword indicating a specific technology with a focus on “convenience”, and a story. FIG. 8D illustrates a keyword indicating an emphasis point with a focus on “competitive analysis”, and a story.

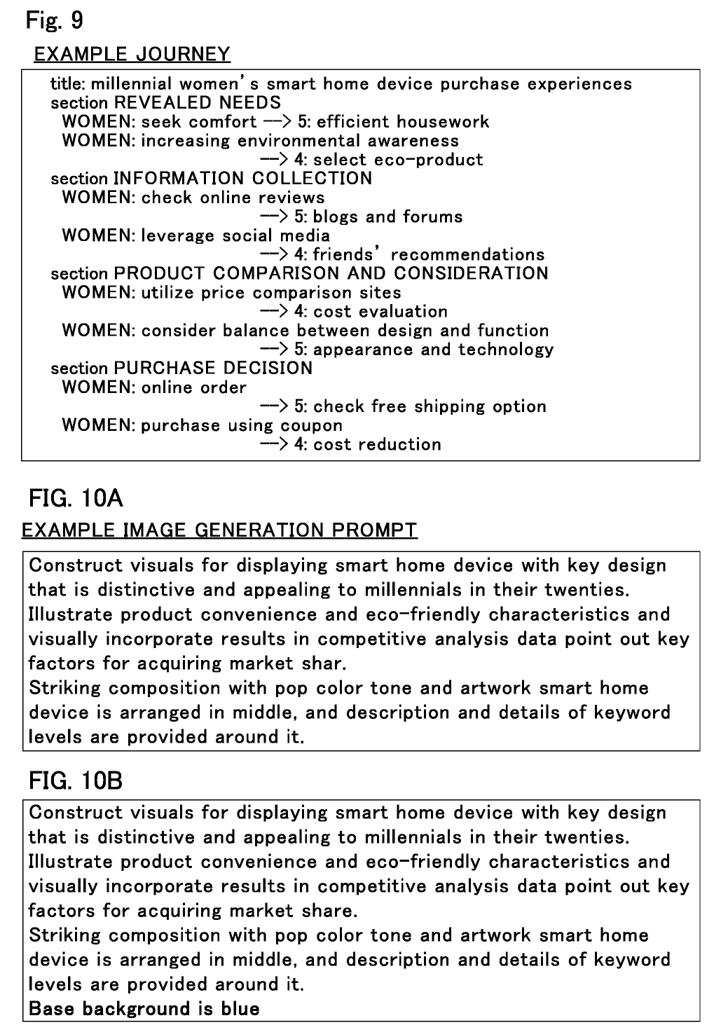

FIG. 9 illustrates an example of the journey. The conceptualization unit 43 acquires, from the generative AI to which the initial prompt is input, the journey with the themes obtained by conceptualizing the visualization data. The journey indicates a process from in a case where a customer manages to find a product until in a case where the customer purchases and utilizes the product, and specifically, as illustrated in FIG. 9, the journey is composed of four sections: “REVEALED NEEDS”,“ INFORMATION COLLECTION”, “PRODUCT COMPARISON AND CONSIDERATION”, and “PURCHASE DECISION”, regarding “millennial women’s smart home device purchase experiences”.

The prompt generation unit 44 generates an image generation prompt including a design for the visualization data by employing the generative AI, with respect to the visualization data, the related data, the features and the relations therebetween, the themes, and the like. FIGS. 10A and 10B illustrate examples of the image generation prompt. Specifically, as illustrated in FIG. 10A, the image generation prompt includes, as the design, for instance, screen composition, such as “a smart home device is arranged in the middle, and description and details of keyword levels are provided around it”, tone and manner, such as “pop color tone”, a use of an image, such as “visuals for display”, and the like.

As illustrated in FIG. 10B, the prompt generation unit 44 may enable the user to edit the image generation prompt in such a way as to make the image generation prompt more specific, for instance, by adding “the base background is blue” or the like for providing a detailed instruction. The prompt generation unit 44 may generate a prompt with respect to a chronology and a relation derived from the keywords, a catchphrase, the journey, the stories, and the like included in the themes.

The image generation unit 45 generates a conceptual image based on the image generation prompt by employing the generative AI and outputs the conceptual image. In other words, the generative AI generates the conceptual image in conformity with the image generation prompt including the design for the visualization data. The image generation unit 45 may input, to the generative AI, the visualization data, the related data, the features and the relations therebetween, the themes, and the like, together with the image generation prompt. The conceptual image may be a still image, such as a picture and artwork, or may be a moving image, such as an animation.

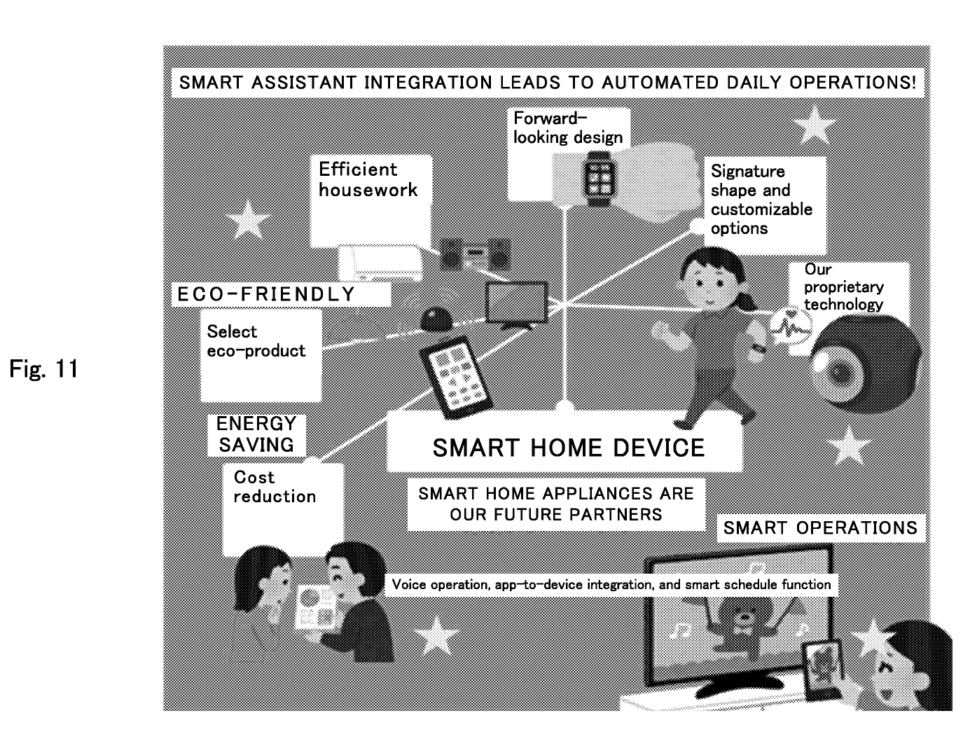

FIG. 11 illustrates an example of the conceptual image. Specifically, the image generation unit 45 generates, employing the generative AI, a conceptual image as illustrated in FIG. 11 based on the image generation prompt as illustrated in FIG. 10B. The conceptual image presents how the product improves their lifestyles as a concept in rich colored graphics, and includes artwork depicting a scenario that the smart home device is used, visualized internal functions of the device, a comparison chart with competitive products, and the like.

The image generation unit 45 transmits the generated conceptual image to the user terminal 2 that makes the image request, and displays the conceptual image. This allows the user to easily acquire the conceptual image in which what is intended to be conveyed is represented by artwork and the like by inputting the visualization data and the related data on the input screen and making the image request.

The feedback unit 46 acquires, from the user terminal 2, feedback from the user who confirms the conceptual image. Specifically, in a case where the user confirms the conceptual image using the user terminal 2, the user transmits, to the server 1, feedback indicating a portion to be corrected, such as “color tone adjustment” and “visualization of additional information”, and a regeneration request for regenerating the conceptual image, by predetermined operations as necessary. The prompt generation unit 44 of the server 1 that obtains the feedback finely adjusts the image generation prompt taking into account the feedback. Next, the image generation unit 45 generates a new conceptual image based on the finely adjusted image generation prompt employing the generative AI, and outputs the new conceptual image. This allows the user who is not satisfied with the conceptual image to easily acquire the new conceptual image subjected to the fine adjustment.

In the above configuration, the visualization data acquisition unit 41, the abstraction unit 42, the conceptualization unit 43, the prompt generation unit 44, the image generation unit 45, and the feedback unit 46 of the server 1 are examples of visualization data acquisition means, abstraction means, conceptualization means, prompt generation means, image generation means, and feedback means of the present disclosure, respectively. The visualization data acquisition unit 41 and the prompt generation unit 44 are an example of an external data acquisition unit of the present disclosure.

### Image generation processing

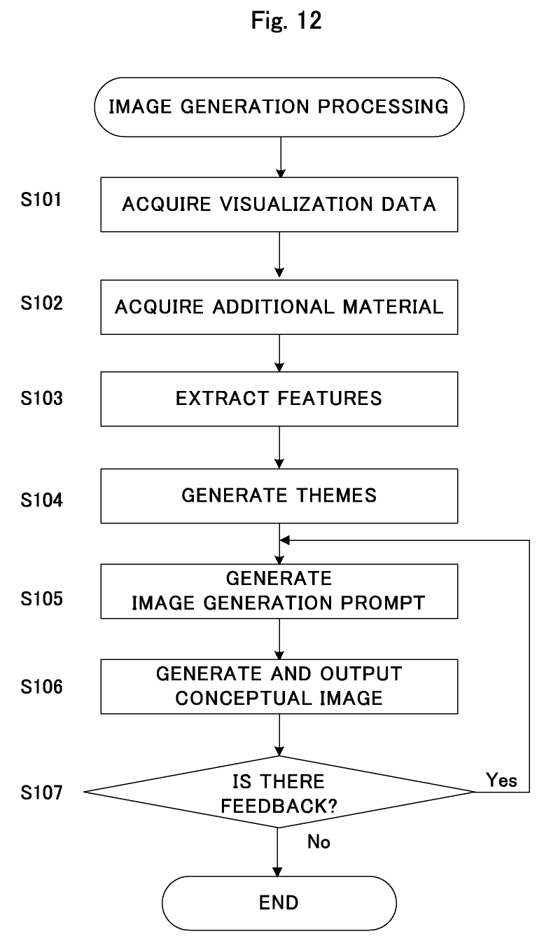

Next, the image generation processing performed by the server 1 will be described. FIG. 12 is a flowchart illustrating an example of the image generation processing performed by the server 1. This processing is achieved by the processor 12 illustrated in FIG. 3A executing the program prepared in advance.

First, the server 1 acquires the visualization data from the user terminal 2 (step S101). The server 1 acquires the additional material from the Internet and/or the predetermined DB with respect to the visualization data (step S102). The server 1 extracts the features from the visualization data with respect to the visualization data and the related data, such as the additional material, and organizes the relations therebetween (step S103). Next, the server 1 generates the themes obtained by conceptualizing the visualization data with respect to the visualization data, the related data, such as the additional material, the features and the relations therebetween, and the like (step S104).

The server 1 generates the image generation prompt employing the generative AI with respect to the visualization data, the related data, the features and the relations therebetween, the themes, and the like (step S105). The server 1 generates the conceptual image employing the generative AI with respect to the image generation prompt, and outputs the conceptual image (step S106). The user confirms the conceptual image output to the user terminal 2 by a predetermined operation, and transmits the feedback and the regeneration request to the server 1 as necessary.

The server 1 determines whether the feedback and the regeneration request are received (step S107). In a case where the feedback and the regeneration request are received (step S107; Yes), the server 1 returns to the processing of step S105, and generates the new image generation prompt with respect to the feedback (step S105) and generates the new conceptual image based on the new image generation prompt (step S106). On the other hand, in a case where the feedback is not received (step S107; No), the server 1 ends the image generation processing.

According to the image generation system 100 with such a configuration, the user can easily acquire the conceptual image in which the purpose and the background the user intends to convey are intuitively conveyed only by inputting the visualization data and making the image request.

Specifically, the server 1 abstracts and conceptualizes inputs given as sentence data and/or image data, and then organizes themes, such as a keyword, a catchphrase, and a story, in a sentence format. Next, the server 1 generates an image generation prompt with respect to the themes in the context of the background and the like as appropriate, and generates, employing the generative AI, a conceptual image including a design that the user intends to convey. This allows not only a user who is not good at expressing his or her intention with a sentence and/or a picture created by himself or herself, but also a user who cannot come up with an idea of expressing his or her intention with a picture in the first place, to easily shape conceptual ideas in his or her head, contents of a conference, and the like into a conceptual image.

Moreover, the server 1 can minimize a deviation from an image that the user intends to visualize by inserting automatic generation of a suitable image generation prompt as a step. The server 1 automatically generates the image generation prompt, which makes it possible to generate a conceptual image without human intervention. Furthermore, unlike generative AI that molds ideas into a typical frame, the server 1 can handle conceptual image generation of various scenes by appropriately generating image generation prompts.

### Modification

A conceptual image may be either a still image, such as a picture and artwork, or a moving image, such as an animation. A server 1 may add an element of an animation to a conceptual image by employing generative AI with respect to an image generation prompt. The server 1 of the present modification is an example of addition means of the present disclosure.

### Second example embodiment

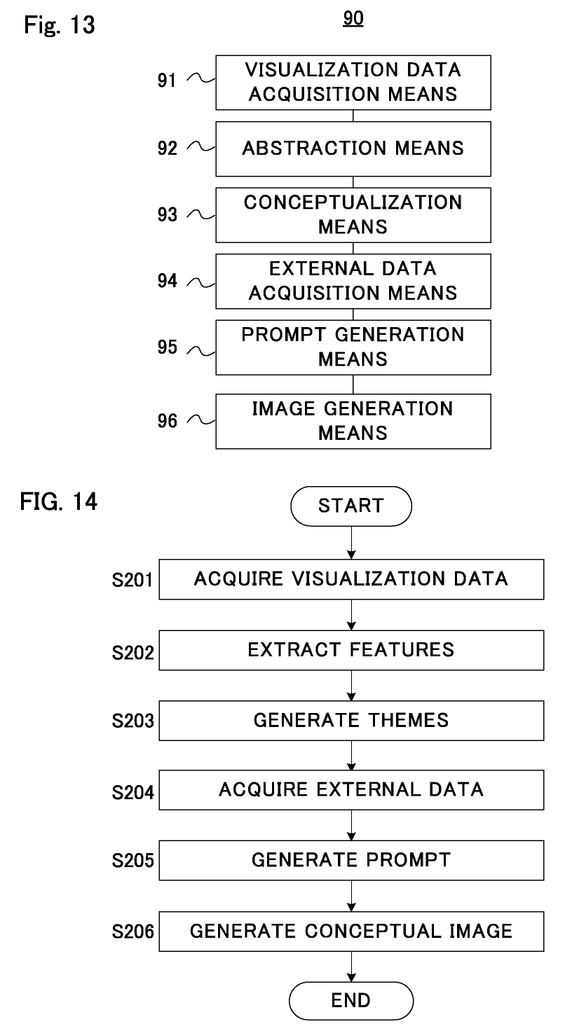

FIG. 13 is a block diagram illustrating an example of the functional configuration of the image generation device in the present disclosure. An image generation device 90 includes visualization data acquisition means 91, abstraction means 92, conceptualization means 93, external data acquisition means 94, prompt generation means 95, and image generation means 96.

FIG. 14 is a flowchart illustrating an example of processing performed by the image generation device 90. The visualization data acquisition means 91 acquires visualization data that is data intended to be visualized (step S201). The abstraction means 92 analyzes the visualization data and extracts features (step S202). The conceptualization means 93 generates themes obtained by conceptualizing the visualization data based on the features (step S203). The external data acquisition means 94 acquires external data with respect to the visualization data (step S204). The prompt generation means 95 generates a prompt including a design representing the visualization data based on the themes and the external data (step S205). The image generation means 96 generates, based on the prompt, a conceptual image in which the external data is reflected (step S206). The image generation device 90 can easily visualize, by utilizing generative AI, what is intended to be conveyed with predetermined data.

Additionally, some or all of the above example embodiments (including modification, the same applies below) may also be described as follows, but are not limited to the following.

### Supplemental Note 1

An image generation device comprising:

visualization data acquisition means configured to acquire visualization data that is data intended to be visualized;

abstraction means configured to analyze the visualization data and extracting features;

conceptualization means configured to generate a theme obtained by conceptualizing the visualization data based on the features;

external data acquisition means configured to acquire external data with respect to the visualization data;

prompt generation means configured to generate a prompt including a design representing the visualization data based on the theme and the external data; and

image generation means configured to generate, based on the prompt, a conceptual image in which the external data is reflected.

### Supplemental Note 2

The image generation device according to Supplemental Note 1, wherein

the abstraction means analyzes the visualization data and organizes the extracted features and a relation therebetween, and

the conceptualization means generates the theme based on the features and the relation therebetween.

### Supplemental Note 3

The image generation device according to Supplemental Note 1, wherein the theme is any one or more of a keyword, a catchphrase, a journey, and a story.

### Supplemental Note 4

The image generation device according to Supplemental Note 3, wherein the prompt generation means generates a prompt with respect to a chronology and a relation derived from the keyword, the catchphrase, the journey, and the story included in the theme.

### Supplemental Note 5

The image generation device according to Supplemental Note 1, wherein the design is any one or more of screen composition, tone and manner, and a use.

### Supplemental Note 6

The image generation device according to Supplemental Note 1, comprising addition means configured to add an element of an animation to the conceptual image.

### Supplemental Note 7

The image generation device according to Supplemental Note 6, comprising

feedback acquisition means configured to acquire feedback from a user who confirms the conceptual image, wherein

the prompt generation means generates a new prompt with respect to the feedback, and

the image generation means generates a conceptual image based on the new prompt.

### Supplemental Note 8

The image generation device according to Supplemental Note 1, wherein the image generation means generates the conceptual image employing generative AI with respect to the visualization data and the prompt.

### Supplemental Note 9

An image generation method executed by an image generation device, the image generation method comprising:

acquiring visualization data that is data intended to be visualized;

analyzing the visualization data and extracting features;

generating a theme obtained by conceptualizing the visualization data based on the features;

acquiring external data with respect to the visualization data;

generating a prompt including a design representing the visualization data based on the theme and the external data; and

generating, based on the prompt, a conceptual image in which the external data is reflected.

### Supplemental Note 10

A program executed by an image generation device including a computer, the program causing the computer to execute processing of

acquiring visualization data that is data intended to be visualized,

analyzing the visualization data and extracting features,

generating a theme obtained by conceptualizing the visualization data based on the features,

acquiring external data with respect to the visualization data,

generating a prompt including a design representing the visualization data based on the theme and the external data, and

generating, based on the prompt, a conceptual image in which the external data is reflected.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Furthermore, some or all of the configurations described as Supplementary Notes can be similarly dependent on not only Supplementary Notes 1, 9, and 10, but also various pieces of hardware and software, and various recording means or systems for recording software without departing from the above-described example embodiments.

While the present disclosure has been described with reference to embodiments, the disclosure is not limited to the example embodiments described above. Various modifications may be made to the configuration and details of a disclosure within the scope of the disclosure as understood by those skilled in the art. That is, the present disclosure naturally includes the entire disclosure, including the claims, and various modifications and alterations that would be made by those skilled in the art in light of the technical concept.

### DESCRIPTION OF SYMBOLS

1 Server

2 User terminal

11, 21 Interface

12, 22 Processor

13, 23 Memory

14, 24 Recording medium

15, 25 Display unit

16, 26 Input unit

41 Visualization data acquisition unit

42 Abstraction unit

43 Conceptualization unit

44 Prompt generation unit

45 Image generation unit

46 Feedback unit

100 Image generation system

1. An image generation device comprising:
at least one memory configured to store instructions; and
at least one processor configured to execute the instructions to:
acquire visualization data that is data intended to be visualized;
analyze the visualization data and extracting features;
generate a theme obtained by conceptualizing the visualization data based on the features;
acquire external data with respect to the visualization data;
generate a prompt including a design representing the visualization data based on the theme and the external data; and
generate, based on the prompt, a conceptual image in which the external data is reflected.

2. The image generation device according to claim 1, wherein
the processor analyzes the visualization data and organizes the extracted features and a relation therebetween, and
the processor generates the theme based on the features and the relation therebetween.

3. The image generation device according to claim 1, wherein the theme is any one or more of a keyword, a catchphrase, a journey, and a story.

4. The image generation device according to claim 3, wherein the processor generates a prompt with respect to a chronology and a relation derived from the keyword, the catchphrase, the journey, and the story included in the theme.

5. The image generation device according to claim 1, wherein the design is any one or more of screen composition, tone and manner, and a use.

6. The image generation device according to claim 1, wherein the processor is further configured to add an element of an animation to the conceptual image.

7. The image generation device according to claim 6, wherein
the processor is further configured to acquire feedback from a user who confirms the conceptual image,
the processor generates a new prompt with respect to the feedback, and
the processor generates a conceptual image based on the new prompt.

8. The image generation device according to claim 1, wherein the processor generates the conceptual image employing generative AI with respect to the visualization data and the prompt.

9. An image generation method executed by an image generation device, the image generation method comprising:
acquiring visualization data that is data intended to be visualized;
analyzing the visualization data and extracting features;
generating a theme obtained by conceptualizing the visualization data based on the features;
acquiring external data with respect to the visualization data;
generating a prompt including a design representing the visualization data based on the theme and the external data; and
generating, based on the prompt, a conceptual image in which the external data is reflected.

10. A non-transitory computer-readable recording medium storing a program executed by an image generation device including a computer, the program causing the computer to execute processing of
acquiring visualization data that is data intended to be visualized,
analyzing the visualization data and extracting features,
generating a theme obtained by conceptualizing the visualization data based on the features,
acquiring external data with respect to the visualization data,
generating a prompt including a design representing the visualization data based on the theme and the external data, and
generating, based on the prompt, a conceptual image in which the external data is reflected.
